(19) United States
(12) Patent Application Publication
(10) Pub. No.: US 2007/0177887 A1
(43) Pub. Date: Aug. 2, 2007

(54) Automatic document feeder sheet misfeed detection system

(76) Inventors: William Haas, Ft. Collins, CO (US); John Carleton, Ft. Collins, CO (US); Kirk Steven Tecu, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/343,840

(22) Filed: Jan. 31, 2006

(51) Int. Cl. G03G 15/00

(52) U.S. Cl. 399/17

(57) ABSTRACT

A sheet misfeed detection system comprises an audio sensor configured to detect an audio signal generated by a sheet fed by an automatic document feeder (ADF) and a detection module configured to detect a misfeed condition of the sheet based on the audio signal generated by the sheet.

### BACKGROUND OF THE INVENTION

Some automatic document feeders (ADF) comprise mechanical and/or optical sensors to detect sheet misfeeds and/or paper jams that occur in the ADF during operation. However, such ADFs contain a limited number of points where the sensors can be located. For example, such ADFs generally comprise one or more optical or mechanical sensors that are spaced apart from each other a specified distance (e.g., at least several inches apart) along the sheet feed path. Thus, detecting a sheet misfeed and/or paper jam is limited to the particular locations of such sensors. Additionally, the non-usability of the misfed and/or jammed paper results in further difficulty in obtaining a copy of such paper.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a diagram illustrating a section view of an image capture device in which an embodiment of a sheet misfeed detection system in accordance with the present invention is employed to advantage;

FIG. 2 is a block diagram illustrating an embodiment of a sheet misfeed detection system in accordance with the present invention; and

FIG. 3 is a flow diagram illustrating an embodiment of a sheet misfeed detection system in accordance with the present invention.

### DETAILED DESCRIPTION OF THE DRAWINGS

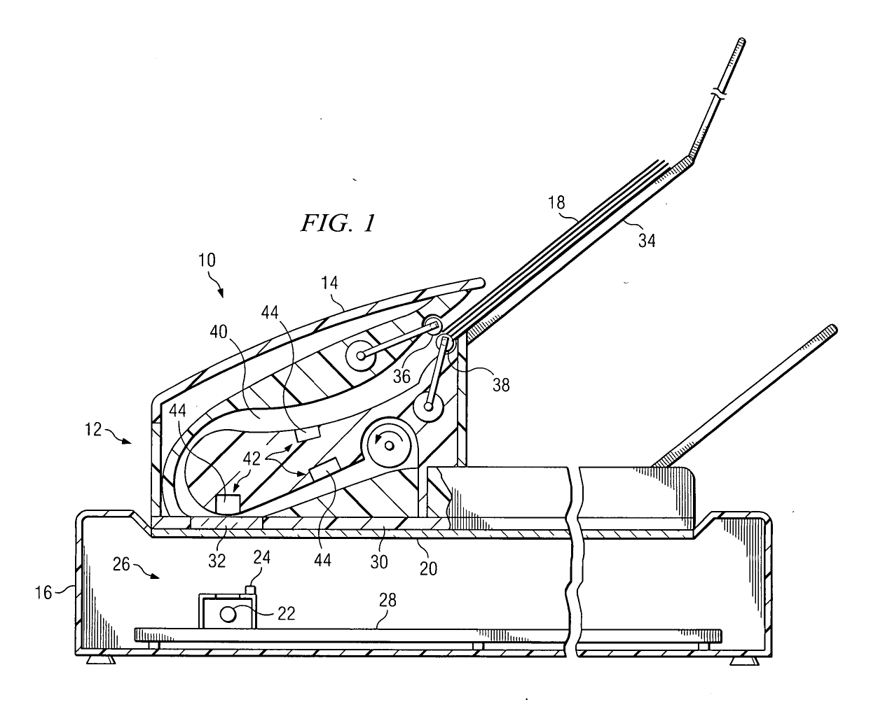

The preferred embodiments of the present invention and the advantages thereof are best understood by referring to FIGS. 1-3 of the drawings, like numerals being used for like and corresponding parts of the various drawings.

FIG. 1 is a diagram illustrating a section view of an image capture device 10 in which an embodiment of a sheet misfeed detection system 12 is employed to advantage in accordance with the present invention. In the embodiment illustrated in FIG. 1, image capture device 10 comprises an automatic document feeder (ADF) 14 coupled to a scanner 16. ADF 14 is configured to sequentially feed one or more sheets 18 to scanner 16 for imaging thereof by scanner 16. It should be understood that image capture device 10 may comprise other types of systems, including, but not limited to, facsimile machines, photocopiers, printers and multi-function devices.

In the embodiment illustrated in FIG. 1, scanner 16 comprises a platen 20, a lamp 22, a photosensor 24, and a carriage 26. Carriage 26 is preferably configured to move lamp 22 and photosensor 24 along a rail 28 relative to a sheet 18 to facilitate scanning of a stationary sheet 18. However, it should be understood that carriage 26 may also remain stationary during a scanning operation while sheet 18 is moved past or relative to photosensor 24 (e.g., via ADF 14).

In the embodiment illustrated in FIG. 1, ADF 14 comprises a surface 30 configured to be disposed against and/or toward platen 20 having a scan window 32 to enable sheet 18 to be exposed to photosensor 24 during feeding of sheet 18 past scanner 16. ADF 14 further comprises an input tray 34 for holding and/or otherwise supporting a stack of sheets 18. In the embodiment illustrated in FIG. 1, ADF 14 is preferably configured to sequentially feed a single sheet 18 at a time past scanner 16 for imaging thereof (e.g., a single sheet 18 is picked up by feed rollers 36 and 38 and driven across scan window 32). Thus, in operation, carriage 26 is positioned below scan window 32 such that light radiated from lamp 22 will pass through platen 20 and scan window 32 and reflect from a portion of sheet 18 adjacent scan window 32. The reflected light returns through scan window 32 and platen 20 and is thereafter collected by photosensor 24 where the light is converted into one or more electric signals representative of a scanned image of the sheet 18. It should also be understood that scanner 16 and/or ADF 14 may be configured for transmissive scanning operations.

In the embodiment illustrated in FIG. 1, misfeed detection system 12 is configured to detect paper jams/misfeeds while sheets 18 are being fed through ADF 14. Typically, when a paper j am/misfeed occurs, sheets 18 become misaligned with a feed path 40, thereby resulting in tearing, wrinkling and/or otherwise damaging the fed sheet 18. In the embodiment illustrated in FIG. 1, sheet misfeed detection system 12 comprises at least one audio sensor 42, such as, but not limited to, a microphone 44, for monitoring and/or detecting sounds associated with a particular sheet 18 misfeed condition (e.g., tearing and/or wrinkling sounds). Preferably, one or more audio sensors 42 are disposed along feed path 40 (e.g., in or near the feed path 40) in a spaced apart relationship relative to each other to audibly detect a sheet 18 misfeed condition. In the embodiment illustrated in FIG. 1, three audio sensors 42 are disposed inside ADF 14 along sheet feed path 40. However, it should be understood that a greater or fewer quantity of audio sensors 42 may be used. Sensor(s) 42 facilitate detection of a misfeed condition for larger or longer “detection zones” in feed path 40, thereby facilitating earlier detection of a misfeed condition. In response to detecting a misfeed condition, an alert signal indicating the misfeed condition is generated (e.g., an audio and/or visual signal) and/or feeding of sheets 18 by ADF 14 is suspended. It should also be understood that audio sensor(s) 42 may be used in combination with other types of misfeed detectors (e.g., mechanical and/or optical sensors).

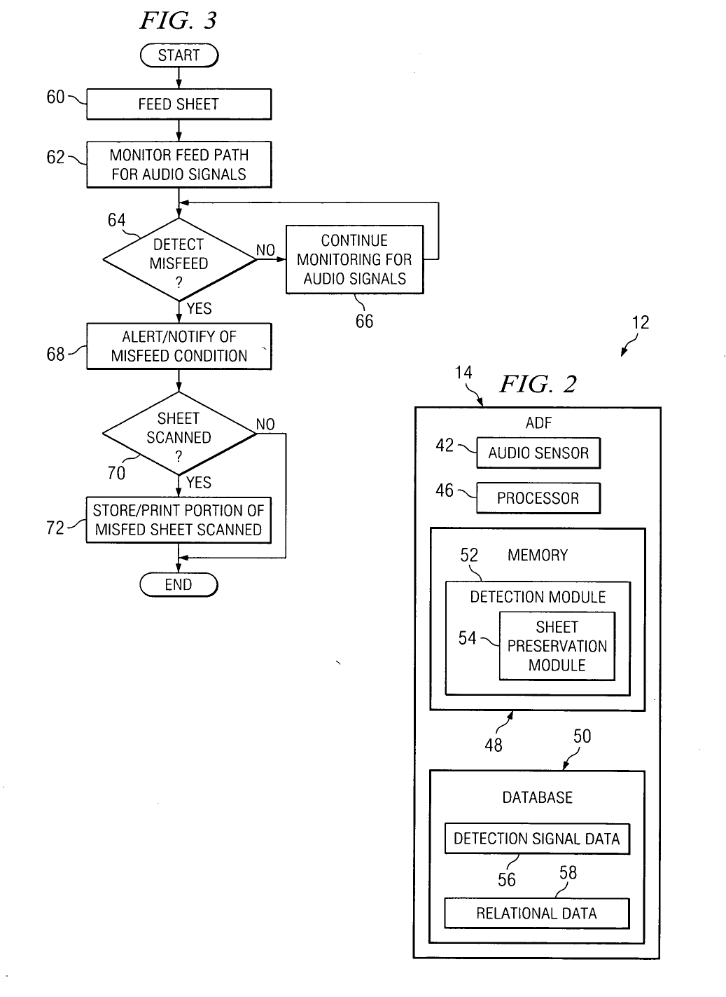

FIG. 2 is a block diagram illustrating an embodiment of sheet misfeed detection system 12 in accordance with the present invention. In FIG. 2, components of system 12 are illustrated as being disposed in and/or forming part of ADF 14. However, it should be understood that various components of system 12 may be located elsewhere (e.g., in scanner 16 or even a remote computer system). In the embodiment illustrated in FIG. 2, system 12 comprises a processor 46 communicatively coupled to audio sensor 42 and a memory 48. In the embodiment illustrated in FIG. 2, memory 48 comprises a database 50 and a detection module 52. Detection module 52 may comprise hardware, software, or a combination of hardware and software. In FIG. 2, detection module 52 is illustrated as being stored in memory 48 so as to be accessible and/or executable by processor 46. However, it should be understood that detection module 52 may be otherwise stored, even remotely. Detection module 52 analyzes the audio signals received from sensor(s) 42 to monitor and/or detect sounds associated with a misfeed condition.

In the embodiment illustrated in FIG. 2, database 50 comprises detection signal data 56 and relational data 58. Detection signal data 56 comprises information associated with audio signals collected by and/or received from audio sensor(s) 42. For example, in some embodiments of the present invention, detection module 52 performs a fast fourier transform (FFT) on the audio signal received from audio sensor(s) 42 to generate detection signal data 56. Relational data 58 comprises information associated with known and/or predetermined audio signal values that are used to evaluate the detection signal data 56 to determine whether sheet 18 has jammed or has otherwise been misfed in ADF 14. For example, in some embodiments of the present invention, relational data 58 comprises known and/or predetermined value ranges (e.g., a predetermined value and associated tolerance) corresponding to a frequency and/or amplitude of audio signal generally associated with a misfeed condition. According to some embodiments of the present invention, relational data 58 can comprise a collection of pre-programmed FFT results from different kinds and/or types of misfeed conditions (e.g., different types of paper, different locations along the feed path 40, etc.).

In operation, detection module 52 compares relational data 58 with detection signal data 56 generated based on audio signals received from audio sensor(s) 42 to determine whether a misfeed condition exists. According to some embodiments of the present invention, detection module 52 comprises a bandpass filter to filter signals of little or no interest (e.g. signals generated from external sounds not related to misfeed conditions such as, but not limited to, voices and other external noises). If detection signal data 56 falls within a predetermined value range indicated by relational data 58, detection module 52 transmits and/or otherwise generates a software interrupt or other signal to alert a user of a misfeed condition. For example, during feeding of sheets 18, audio sensor(s) 42 monitors the feed path 40 for sounds generated by sheet 18 to detect wrinkling, tearing or other sounds generally associated with a misfeed condition of sheet 18. Such audio information is stored in memory 48 as detection signal data 56. Detection module 52 compares the detection signal data 56 with relational data 58 to determine whether the sheet 18 has been torn, wrinkled and/or otherwise damaged indicative of a misfeed condition. For example, in response to a wrinkling condition of sheet 18 within feed path 40, audio sensor(s) 42 detect the associated sounds generated by sheet 18 as a result of being wrinkled and/or otherwise damaged. Accordingly, the sounds detected by audio sensor(s) 42 as indicated by detection signal data 56 are used by detection module 52 to detect a misfeed condition (e.g., the detection signal data 56 falling within a predetermined or known value range as indicated by relational data 58). In response to detecting a paper jam/misfeed condition, detection module 52 transmits an alert and/or otherwise notifies a user of the paper jam/misfeed condition.

In response to detecting a misfeed condition, a sheet preservation module 54 of detection module 52 is configured to automatically store, print and/or otherwise output a scanned image of sheet 18 (e.g., in image containing at least that portion of the misfed sheet 18 that has been scanned before detecting the misfeed condition). For example, as sheet 18 is fed through ADF 14, a portion of sheet 18 may have been driven across scan window 32 and imaged by photosensor 24 before detecting a misfeed condition. In some embodiments of the present invention, in response to detecting a misfeed/jammed condition, sheet preservation module 54 automatically generates and/or stores an image of the sheet 18 containing at least a portion of sheet 18 that has been scanned in a user-accessible storage location and/or as a user-accessible file, thereby preserving at least a portion of such sheet 18 (e.g., in electronic image format) in the event that sheet 18 is destroyed or otherwise unusable. Additionally, or alternatively, system 12 is configured to automatically output the image of the scanned portion of sheet 18 (e.g., a print version and/or output to a display).

FIG. 3 is a flow diagram illustrating an embodiment of a misfeed detection method in accordance with the present invention. The method begins at block 60, where a sheet 18 is fed by ADF 14 for imaging. At block 62, audio sensor(s) 42 monitor feed path 40 for audio signals or sounds indicative of a misfeed condition of the sheet 18. At decisional block 64, a determination is made whether a sheet misfeed condition exists (e.g., by comparing detection signal data 56 associated with monitoring of feed path 40 with relational data 58). If a determination is made that no misfeed condition is detected, the method proceeds to block 66 where system 12 continues to monitor feed path 40 for audio signals indicative of a misfeed condition. If at decisional block 64 a misfeed condition is detected, the method proceeds to block 68, where an alert or notification of the misfeed condition is generated (e.g., an audible signal and/or visual signal). At decisional block 70, a determination is made whether any portion of the sheet 18 has been scanned prior to detecting the misfeed condition (e.g., a portion of sheet 18 may have been driven across scan window 32 (FIG. 1) and imaged by photosensor 24 (FIG. 1) prior to the misfeed condition). At block 72, if a portion of sheet 18 has been scanned prior to detecting the misfeed condition, system 12 automatically stores, prints and/or otherwise outputs a scanned image of the sheet 18 containing at least a portion of the sheet 18 that has been scanned.

Thus, embodiments of the present invention provide for larger or longer “detection zones” in the sheet feed path of the ADF 14 by detecting misfeeds/paper jams using audio sensor(s) 42. Furthermore, embodiments of the present invention enable at least a portion of sheet 18 that has been scanned to be stored and/or output in response to detecting a misfeed condition.

What is claimed is:

1. A sheet misfeed detection system, comprising:
an audio sensor configured to detect an audio signal generated by a sheet fed by an automatic document feeder (ADF); and
a detection module configured to detect a misfeed condition of the sheet based on the audio signal generated by the sheet.

2. The system of claim 1, wherein the audio sensor comprises a microphone.

3. The system of claim 1, wherein the audio sensor is disposed within a feed path of the ADF.

4. The system of claim 1, wherein the detection module is configured to compare the audio signal detected by the audio sensor to relational data to detect the misfeed condition.

5. The system of claim 1, wherein the detection module performs a fast fourier transform on the audio signal detected by the audio sensor.

6. The system of claim 1, further comprising a preservation module configured to store a scanned image of at least a portion of the sheet in response to detecting a misfeed condition.

7. A sheet misfeed detection system, comprising:
means for detecting an audio signal generated by a sheet fed by an automatic document feeder (ADF); and
means for detecting a misfeed condition of the sheet based on the audio signal generated by the sheet.

8. The system of claim 7, wherein the means for detecting the audio signal comprises a microphone.

9. The system of claim 7, wherein the means for detecting the audio signal is disposed within a feed path of the ADF.

10. The system of claim 7, wherein the means for detecting a misfeed condition is configured to compare the audio signal to relational data to detect the misfeed condition.

11. The system of claim 7, further comprising a means for storing a scanned image of at least a portion of the sheet in response to detecting a misfeed condition.

12. A misfeed detection system, comprising:
an automatic document feeder (ADF) for automatically feeding at least one sheet to an image capture device; and
preservation module configured to generate a scanned image of at least a portion of the at least one sheet in response to detecting a misfeed condition associated with the at least one sheet.

13. The system of claim 12, further comprising an audio sensor for detecting the misfeed condition.

14. The system of claim 12, wherein the preservation module is configured to output the scanned image of the at least one sheet.

15. A method of manufacturing a sheet misfeed detection system, comprising:
providing an automatic document feeder (ADF);
providing an audio sensor configured to detect an audio signal generated by a sheet fed by the ADF; and
providing a detection module configured to detect a misfeed condition of the sheet based on the audio signal generated by the sheet.

16. The method of claim 15, wherein providing an audio sensor comprises providing a microphone.

17. The method of claim 15, further comprising disposing the audio sensor within a feed path of the ADF.

18. The method of claim 15, further comprising configuring the detection module to compare the audio signal detected by the audio sensor to relational data to detect the misfeed condition.

19. The method of claim 15, further comprising configuring the detection module to performs a fast fourier transform on the audio signal detected by the audio sensor.

20. The method of claim 15, further comprising providing a preservation module configured to generate a scanned image of at least a portion of the sheet in response to detecting a misfeed condition.
